(19) United States
(12) Patent Application Publication
(10) Pub. No.: US 2010/0191594 A1
(43) Pub. Date: Jul. 29, 2010

(54) SYSTEMS AND METHODS FOR REWARD TRANSACTION MATCHING AND SETTLEMENT

(76) Inventors: Brigette White, Cortland Manor, NY (US); Randy Jeffrey Schafer, East Brunswick, NJ (US); Raegen A. Lang, Fairview Heights, IL (US); Brenda Daugherty Ellis, Ballwin, MO (US)

Correspondence Address: BUCKLEY, MASCHOFF & TALWALKAR LLC, 50 LOCUST AVENUE, NEW CANAAN, CT, 06840, US

(21) Appl. No.: 12/533,457

(22) Filed: Jul. 31, 2009

Related U.S. Application Data
(60) Provisional application No. 61/147,876, filed on Jan. 28, 2009.

(51) Int. Cl. G06Q 30/00; G06Q 10/00; G06Q 20/00

(52) U.S. Cl. 705/14.28; 705/14.27; 705/30; 705/39

(57) ABSTRACT

A reward processing method, system, apparatus, and computer program code is provided. Pursuant to some embodiments, the method includes analyzing transaction data associated with a plurality of payment transactions, each payment transaction including data identifying a payment account identifier, a transaction date, a transaction amount, and a merchant identifier, and identifying a first set of the payment transactions involving registered payment account identifiers. A second set of payment transactions involving a registered merchant identifier and a current offer are identified, and a reward amount earned for each of the second set is calculated. The reward amount is credited to each of the payment account identifiers in the second set.

### RELATED APPLICATIONS

This application is based on, claims benefit and priority to, U.S. Provisional Patent Application Ser. No. 61/147,876, filed on Jan. 28, 2009 the contents of which are hereby incorporated by reference in their entirety.

### BACKGROUND

Embodiments disclosed herein relate to reward or loyalty systems. In particular, some embodiments relate to methods, apparatus, systems, means and computer program products for reward transaction matching and settlement.

Payment card loyalty programs have been in widespread use for some time. Most consumers who hold payment cards participate in some form of loyalty program, including merchant-specific frequent buyer programs, airline mileage programs, or the like. In general, these programs are successful, as many consumers who participate in loyalty programs indicate that their participation in the programs has an impact on their purchasing decisions.

Unfortunately, the ubiquity of these programs has led to dilution of their impact. With so many programs, and so little differentiation, customers' behaviors are not directly driven by the programs. As a result, many customers do not actively participate in many loyalty programs even after they have enrolled.

The reward delivery mechanism for most loyalty programs has primarily been the use of store coupons, statement inserts or other printed coupons that require a customer to redeem the coupon in a future purchase. Currently, it is estimated that the percentage of reward coupons that are redeemed by customers is less than 1% of the total coupons distributed.

Further, many programs are either merchant-specific, or payment card issuer-specific. For example, some merchants offer discounts or rebates for usage of a store credit card (such as a private label or co-brand credit card) for making purchases at the merchant's locations. Unfortunately, however, there are no rewards programs that allow payment cardholders to enjoy discounts or rewards for purchases made at different merchant locations where discounts or rewards may further be based on specific product or item purchases.

Further, many merchants simply do not have the expertise or ability to effectively use their customer data to develop and administer reward programs. It would be desirable to reduce the barriers to consumers to make it easier for them to participate and receive rewards from a variety of different merchants. It would further be desirable to allow consumers to receive rewards based on the purchase of specific items or products at different merchants. It would further be desirable to provide systems and methods that allow merchants to easily deploy and administer rewards programs.

### BRIEF DESCRIPTION OF THE DRAWINGS

Features and advantages of some embodiments of the present invention, and the manner in which the same are accomplished, will become more readily apparent upon consideration of the following detailed description of the invention taken in conjunction with the accompanying drawings, which illustrate preferred and exemplary embodiments and which are not necessarily drawn to scale, wherein:

FIG. 1 is a block diagram of a payment system provided according to certain embodiments.

FIG. 2 is a flow chart that illustrates a transaction process pursuant to some embodiments.

FIG. 3 is a flow chart that illustrates a merchant setup process pursuant to some embodiments.

FIGS. 4A and 4B are flow diagrams that illustrate a transaction process pursuant to some embodiments.

### DETAILED DESCRIPTION

In general, and for the purpose of introducing concepts of some embodiments of the present invention, a number of different merchants may participate in (and, in some embodiments, fund) one or more rewards programs for the benefit of their customers who make certain incentivized purchases using a registered payment card. Pursuant to some embodiments, a reward servicing entity acts to manage and administer the merchant reward programs. The reward servicing entity interacts with a payment card association to identify qualifying purchase transactions made by registered payment cardholders. Once qualifying transactions are identified, the reward servicing entity determines the appropriate reward or discount amount for each qualifying transaction and interacts with the payment card association to ensure the cardholder receives the reward or discount amount (e.g., as a credit to the cardholder's account).

Pursuant to some embodiments, a merchant matching process is performed when new merchants are setup as participants in the rewards system. In the merchant matching process, each merchant is uniquely identified, so that each merchant can offer rewards of its own choosing and so that reward amounts are appropriately settled among the appropriate parties. For example, using features of embodiments of the present invention, a specific franchise store in a nationwide franchise can offer its customers rewards that differ from the rewards offered by other stores in the franchise.

Pursuant to some embodiments, the rewards servicing entity (or entities) settle with the payment card association by prefunding reward obligations so that cardholders who have earned discounts or rewards may be paid in a timely and reliable manner.

The result are methods, apparatus, systems, means and computer program products for reward transaction matching and settlement that solve a number of problems associated with rewards programs.

These systems and methods allow for reward amounts earned to be automatically and conveniently credited to payment card accounts of customers who participate in rewards programs, while efficiently settling the amounts of the rewards with the merchants. Processing and administrative economies are realized by using a previously existing payment processing network as the vehicle for payment and funding of rewards amounts. Little or no modification of the payment processing network itself is required, since a separate rewards system computer is associated with the payment processing network to generate the reward transactions to be handled through existing mechanisms of the payment processing network.

For convenience and clarity, a number of terms are used herein. For example, the term “payment card” is used to refer to a card, number, or other device that allows a payment cardholder to authorize the payment of funds from an account associated with the payment card to a merchant or other service provider. Payment cards may include debit cards, prepaid cards or credit cards, and may be in any of a number of form factors, including chip cards, RFID cards, plastic cards, virtual cards, or the like. Further, although the term “payment card” implies the use of a physical card or device, no such physical card or device is required (the term is used for convenience and ease of exposition). Instead, embodiments may be used with any of a number of different types of payment accounts that are processed through a payment network.

The term “payment processing network” is used to refer to a payment processing network that performs authorization, clearing and settlement of payment transactions. For example, embodiments described herein are described as using a payment processing network such as the network operated by MasterCard International Incorporated, which acts to obtain authorizations for individual payment transactions and to effect settlement of funds between, for example, merchants and consumers.

The term “reward”, “rebate”, “offer” or “discount” is used to refer to an amount calculated based on the usual list price (or based on a sale or reduced price) of an item or a transaction amount that is to be credited to a cardholder account subsequent to the actual purchase. As used herein, the terms of a specific “reward” are typically established by a participating merchant, issuer, or payment association. Rewards may include any of a number of types of calculations, such as a set percentage or amount of a total transaction, a set percentage or amount of an item's price, or the like. Rewards may also be delivered or measured in terms of points, airline miles, cash back amounts, or the like. Further, as used herein, “rewards” may include loyalty programs (e.g., such as a frequent shopper program), and reward programs established by payment card issuers. In general, some or all of the techniques described herein may be used with rewards programs as well as with loyalty programs. In general, as used herein, those terms are used interchangeably. Those skilled in the art, upon reading this disclosure, will appreciate that a number of different forms of reward, loyalty or discount programs may be efficiently administered using features of the present invention.

The term “merchant” is used to refer to a vendor of goods or service. The term “merchant” as used herein, may also imply a particular merchant location or group of locations. For example, a participating “merchant” may be a single physical storefront, Internet address, or mail order or catalog. A participating “merchant” may also be a group of physical storefronts, Internet locations or the like (e.g., such as a chain, a franchise, a geographic region, etc.). In some embodiments, a “merchant” may be a group of merchants defined, for example, based on location (e.g., such as zip code, State, country, latitude and longitude, a radius from a location, etc.).

The term “stock keeping unit” or “SKU” is commonly used (and is used herein) to refer to a specific product or service that is vended or sold by a merchant. As used herein, the term “SKU-level discount” is used to refer to a discount that is credited or awarded based on the purchase of a specific product or service (identified by it's SKU).

The term “POS” or “POS location” refers to point of sale locations or “points of transaction” such as Internet commerce sites that receive payment account numbers from customers who shop online, mail order or telephone (MOTO) merchants who receive payment account numbers by telephone and/or mail, and physical point of sale terminals located in brick-and-mortar retail stores.

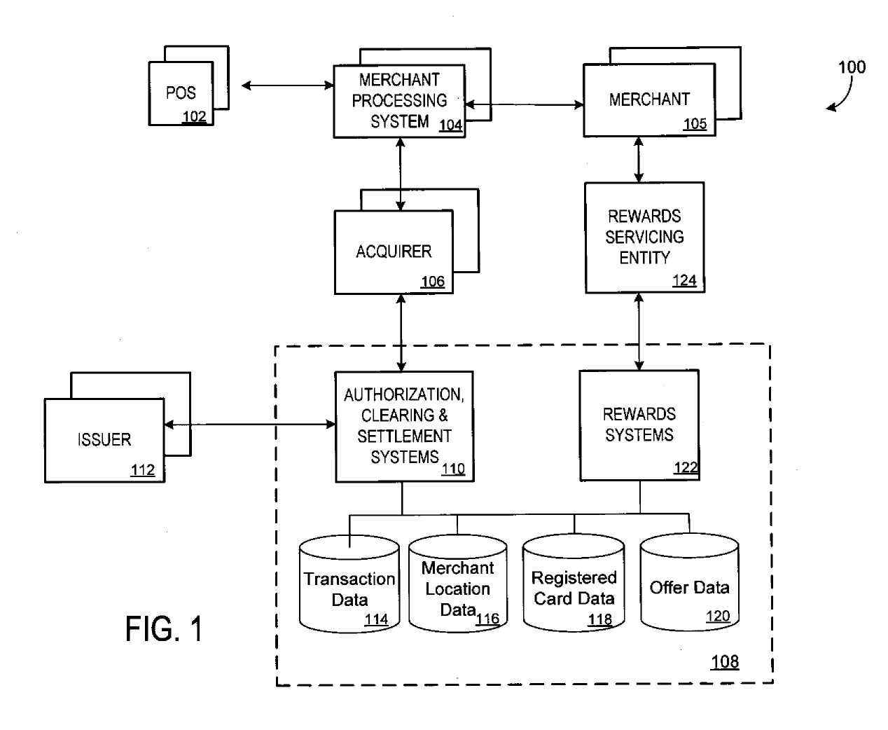

Features of some embodiments of the present invention will now be described by first referring to FIG. 1 which is a block diagram representation of a payment system 100 provided according to certain embodiments. As depicted, the payment system 100 includes a plurality of POS locations 102. In the case of physical point of sale terminals, a payment card (not shown) is presented at the POS by a customer and read by the POS terminal to input the number of the payment card account to which a purchase transaction is to be charged or from which funds are to be debited. In the case of other types of POS locations, the payment card account number may be input into the POS location by human data entry or the like.

The system 100 also includes a number of merchant processing systems 104. As is known to those of skill in the art, a number of POS locations 102 may be connected to each merchant processing system 104. Each merchant processing system is in communication with an acquirer system 106. Each merchant processing system 104 is a computer or computer system that receives transaction data from the POS locations connected to it and that forwards authorization requests and requests to settle purchase transactions to an acquirer system 106. In the case of an Internet shopping site, the POS location(s) and the merchant processing system may be integrated together into a single computer system. In some cases (not illustrated), the POS location 102 may communicate directly with an acquirer computer 106, without an intervening merchant processing system. The term “acquirer” is widely used in the payment processing field, and refers to financial institutions such as banks or other financial systems that have agreement with merchants to receive and forward purchase transaction authorizations and settlement requests on behalf of the merchants. The term “acquirer” also refers to processing agents that act on behalf of such financial institutions or systems. Each acquirer typically serves numerous merchants, and accordingly each acquirer system 106 is shown as being in communication with numerous merchant processing systems 104. Moreover, a typical payment processing network serves numerous acquirers, and FIG. 1 therefore schematically depicts a plurality of acquirer systems 106.

In addition to the acquirer systems 106, the payment system 100 includes a payment processing network 108. The payment processing network 108 is in communication, at least from time to time, with the acquirer systems 106, and may be operated by or on behalf of a payment card association such as MasterCard International, Inc. The payment processing network 108 receives purchase transaction authorization and clearing requests (e.g., substantially in real-time in the case of authorization requests, and batched, in the case of clearing requests), from the acquirer systems 106. The payment processing network 108 includes authorization, clearing and settlement systems 110 that function to ensure that payment transactions involving payment cards are authorized by the payment card issuer 112, and that funds are cleared and settled for each transaction between the merchant and the issuer 112. Pursuant to embodiments of the present invention, the payment processing network 108 also includes one or more rewards systems 122 configured to process rewards transactions pursuant to embodiments of the present invention. Rewards systems 122 utilize data stored at, or accessible to, the payment processing network 108 to ensure that rewards-eligible transactions are identified, that reward amounts are properly credited to payment cardholders, and settled with merchants. For example, as depicted, rewards systems 122 utilize transaction data 114, merchant location data 116, registered card data 118, and offer data 120 to qualify and process reward transactions. The use of this data will be described in further detail below.

The authorization, clearing and settlement systems 110 operate to authorize, clear, and settle purchase transaction requests that the payment processing network 108 has received from acquirer computers, and for which the payment processing network 108 has determined clearing destinations (i.e., issuers). The systems 110 are also used to clear and settle reward payment transactions (e.g., the transactions in which cardholder accounts are credited with the amount of rewards they have earned, and the rewards servicing entity 124 is debited in the amount rewards paid to cardholders).

FIG. 1 also shows, as part of the payment system 100, a plurality of issuer systems 112. Issuer systems 112 are operated by financial institutions (or their processing agents) that have issued the payment cards used by customers in connection with the payment system 100. In the case of MasterCard International, Inc., numerous issuers participate in the MasterCard payment processing network, and accordingly numerous issuer computers 112 receive authorization, clearing, and settlement messages from payment processing network 108. As is well-known, the issuers maintain payment card accounts of the cardholders. The authorization, clearing and settlement messages from the payment processing network 108 include information identifying particular payment card accounts that are associated with payment transactions, and also include information identifying amounts to be authorized, cleared or settled.

A number of the elements of the payment system 100 depicted in FIG. 1 may be conventional and may operate in a substantially conventional manner. However, in accordance with principles of the present invention, the payment system 100 may also include or have associated therewith a rewards system 122 and a rewards servicing entity 124. The rewards system 122 may be connected (at least from time to time) with one or more data sources (including the transaction data 114, the merchant location data 116, the registered card data 118 and the offer data 120) in such a manner as to allow the rewards system 122 to identify purchase transactions as being potentially eligible for one or more rewards.

The rewards system 122 may also be in communication, at least from time to time, with the authorization, clearing and settlement systems 110 and with the rewards servicing entity 124 to allow the rewards system 122 to provide and receive data to and from the systems 110 and the entity 124 to facilitate the processing of rewards transactions pursuant to the present invention. Details of operation of the rewards system 122 will be described below. Suffice it to say for the moment that the rewards system 122 may interact and cooperate with the rewards servicing entity 124 to administer rewards programs, including programs that provide rewards to cardholders, and that the rewards system 122 may initiate transactions to be cleared through the payment processing network so that (1) the issuer is paid the amount of the reward (for the issuer to apply to the relevant cardholder accounts), and (2) to debit a corresponding reward amount from an account associated with the rewards servicing entity 124.

As depicted in FIG. 1, payment network 100 also includes a rewards servicing entity 124 which is in communication with one or more merchants 105 and the rewards systems 122 of the payment processing network 108. Pursuant to some embodiments, the rewards servicing entity 124 is a separate entity than the payment processing network 108. In some embodiments, the rewards servicing entity 124 is operated by, or on behalf of, the payment processing network 108. In either event, the rewards servicing entity 124 serves to interface with merchants 105 who wish to participate in the rewards program of the present invention. For example, as will be described further below, the rewards servicing entity 124 may establish contractual relationships with merchants 105, collect information needed to set the merchants up in the rewards system, and track and manage the merchant reward offerings that are available. Pursuant to some embodiments, consumers are able to enjoy the benefits of program participation without need to register (e.g., in some embodiments, consumer cardholders may be automatically registered by virtue of their holding a payment card issued by a participating issuer).

The rewards servicing entity 124, in some embodiments, on a regular (such as daily) basis, assembles and manages a database of daily reward offers for participating merchants 105. Further, the rewards servicing entity 124 processes daily transaction data (received from the payment processing network 108) that have been marked as possibly qualifying for a reward and determines whether a transaction actually qualifies for a reward. In some embodiments, the rewards servicing entity 124 also acts to settle funds with merchants for those transactions that qualified for a reward so that cardholders who have earned a reward can be paid. In some embodiments, as will be described further below, the rewards servicing entity 124 settles with merchants and with the payment processing network 108 on a daily, or other regular basis. The payment processing network 108 causes the appropriate funds to then be credited to cardholder accounts.

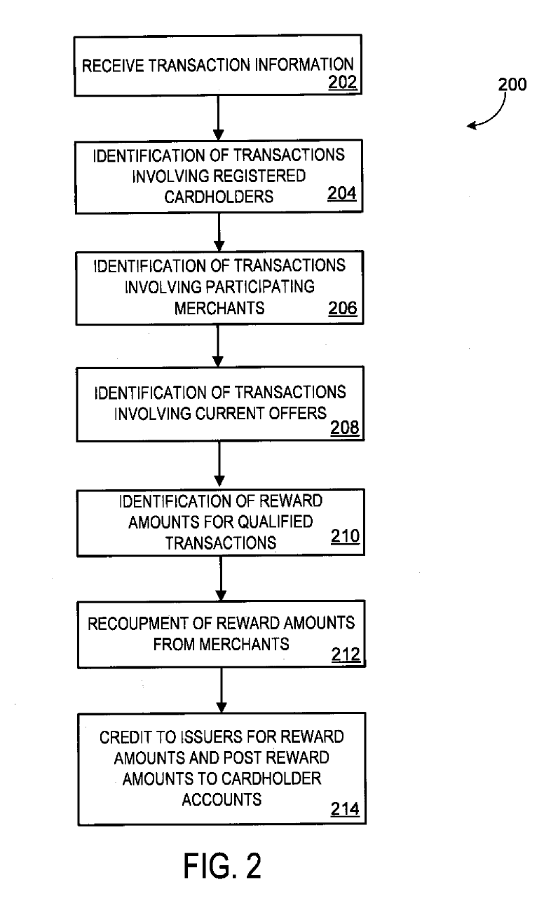

FIG. 2 is a flow chart that illustrates a transaction process performed in accordance with aspects of the present invention in the system of FIG. 1. In part, the process illustrated in FIG. 2 may be considered to represent the “life cycle” of a purchase transaction in a payment processing network that, in accordance with aspects of the invention, results in a cardholder being credited with an amount of a reward and a merchant being debited to fund the reward.

At 202 in FIG. 2, transaction information is received (e.g., by the payment processing network 108 of FIG. 1) for analysis. For example, the transaction information may include all transactions that occurred over a payment processing network 108 over a given period (e.g., such as the previous 24 hours, or some other cycle). The transaction information may be accessed from a data warehouse such as the transaction data store 114 of FIG. 1. The transaction data may be filtered by geographical region (e.g., such as U.S.-only transactions) or other filters that narrow the data set to include only those transactions that could possibly include reward-eligible transactions. In some embodiments, processing at 202 is performed on a nightly (or almost every night) basis.

Processing continues at 204 where the transaction information identified in 202 is further filtered to include only those transactions that involved “registered cardholders”. In some embodiments, a “registered cardholder” is a payment cardholder who has opted in (e.g., registered, or otherwise indicated a desire) to participate in the rewards program of the present invention (or, to identify cardholders who were automatically enrolled by their card issuer). In some embodiments, a cardholder holding a payment card that is eligible for participation may enroll to participate by visiting a Website or calling a phone number that is operated by the rewards servicing entity 124, the payment processing network 108, or the issuer of the payment card and providing the payment card account number that the cardholder will use to participate in the rewards program. Once a cardholder has elected to participate, the payment card account number(s) that is/are associated with the cardholder and that are registered in the rewards program are stored in a registered card database (such as the database 118 of FIG. 1). Processing at 204 involves filtering the set of transaction data identified at 202 to remove any transactions that did not involve a registered cardholder. In some embodiments, processing at 204 involves querying a data warehouse that contains registered cardholder data.

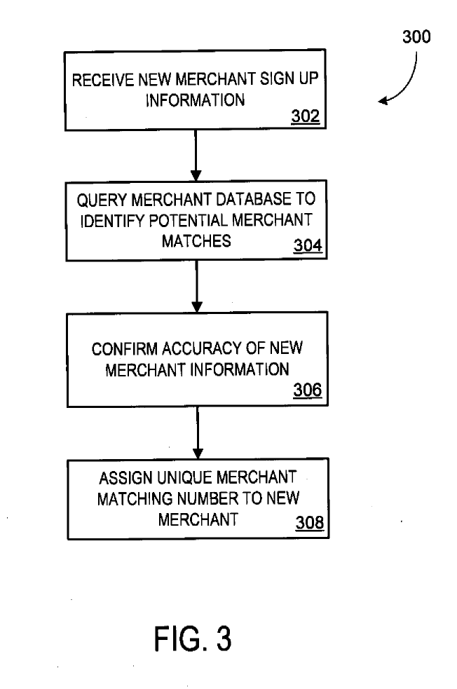

Processing continues at 206 where the filtered set of transaction data generated at 204 is further processed to include only those transactions involving registered cardholders that were made at merchants that are participating in the rewards program of the present invention. Registered cardholders may make purchases with their payment cards at a huge number of different merchants. Some of those merchants may be participants in the reward program, and some may not be participants. Processing at 206 involves identifying only those transactions which were made at participating merchants, regardless of whether they have an active or have had a recent offer. For example, processing at 206 may involve comparing the dataset created at 204 with a database of participating merchants using merchant location data (e.g., from the merchant location database 116 of FIG. 1). Pursuant to some embodiments, a unique merchant identifier is assigned to each participating merchant. The unique merchant identifier, in some embodiments, may be based on (or the same as) existing merchant identifiers that are assigned to merchants that accept payment cards of the payment network (for example, merchants that accept MasterCard® payment cards may each be assigned a unique merchant identifier). Each transaction record received from a merchant or merchant acquirer includes the unique merchant identifier. Processing at 206 includes matching the unique merchant identifier of transactions involving registered cards with a dataset of merchants participating in the rewards program. The creation of the set of merchants participating in the rewards program is described further below in conjunction with FIG. 3. In some embodiments, processing at 206 includes performing one or more geographic or other checks to determine if a particular merchant location is a participating merchant location. For example, processing may include identifying a geographic location of the merchant and then comparing that location to a rule set which defines which merchant locations are participating in a particular reward. The geographic check may include comparing the zip code of a merchant location to a set of participating zip codes, comparing a latitude and longitude to a region of participating locations, etc.

Processing continues at 208 where the filtered set of transaction data created at 206 (i.e., the data identifying transactions that were made using a registered payment card and that were conducted with a participating merchant) is further processed to identify those transactions which were conducted at merchants that, as of the date of processing, offered a current discount (or, in some embodiments, that offered a discount or reward that expired within a recent period of time, such as the last 90 days). Processing at 208 involves comparing the transaction list generated at 206 with an offer database (such as database 120 of FIG. 1) to identify only those transactions that may involve a reward offer. At this stage, a set of transactions remains which meets the following criteria: (i) they were conducted with registered payment cards, (ii) they were conducted at merchants who are participating in the rewards program, and (iii) they were conducted at merchants who offer a current (e.g., within 90 days) reward offer.

In some embodiments, the “filtering” at 204, 206 and/or 208 is performed in a single operation. For example, in some embodiments, the data required to perform the filtering at 204, 206 and/or 208 may be stored in a data warehouse, and the filtering may be performed in one or more queries to the data warehouse. In some embodiments, the filtering at 204, 206 and/or 208 are performed with multiple queries to one or more datastores. In either event, the resulting dataset (e.g., at the conclusion of 208) includes only those transactions that have been conducted using a registered card and that have been conducted at merchants who are participating in the rewards program, and that were conducted at participating merchants that have current reward offers. Pursuant to some embodiments, the set of data resulting from the filtering of 204, 206 and 208 is packaged into a file or dataset that may be transmitted or provided to a system or entity for final qualification of reward offers at 210. As used herein, this dataset or file resulting from processing at 204, 206 and 208 will be referred to as a “pre-qualified transaction” (PQT) file.

Processing continues at 210 where the PQT file is processed to specifically identify those transactions in the PQT file that are due a reward or discount. In some embodiments, processing at 210 is performed by a rewards servicing entity (such as the entity 124 of FIG. 1). In some embodiments, processing at 210 is performed by the payment network (such as entity 108 of FIG. 1) or some other entity.

Processing at 210 includes comparing the transaction data in the PQT with detailed information about each current merchant offer. For example, this may include comparing the purchase amount, time/date, specific merchant location (as appropriate) and other transaction details with offer details in an offer database to specifically identify those transactions that qualify for a reward or discount. In embodiments in which SKU-level discounts are offered, processing at 210 may include processing to receive SKU-level details from the merchant with the transaction data. For example, a transaction file may be provided which includes a transaction date, a total transaction amount, merchant identifying information (e.g., a merchant name, a merchant address, a DBA, etc.), SKU-level information (e.g., such as items, quantity, etc.), and the last four digits of the payment card used in each transaction. Processing at 210 may include matching the transaction level detail with the PQT to identify pending transactions that may be reward-eligible. In this manner, SKU-level discounts may be provided despite the lack of SKU-level transaction details in many existing payment authorization networks.

If a transaction is determined to qualify for a reward or discount, processing at 210 further includes calculating the amount of the reward or discount earned (again, by reference to the terms and conditions of the offer in an offer database). Processing at 210 results in the creation of a fully-qualified transaction (“FQT”) file which includes, for example, the transaction information and the amount of the reward or discount to be paid to the cardholder. In the situation where processing at 210 is performed by an entity other than the payment network, processing at 210 includes transmitting or providing the FQT file to the payment processing network (e.g., via file transfer protocol, email, or the like).

Pursuant to some embodiments, processing at 210 results in the creation of a FQT that only contains transactions that have been fully-qualified for rewards or discounts. Those transactions that do not qualify will be held by the rewards servicing entity 124 for further analysis. In some embodiments, the transactions that have not been fully qualified will be marked with a reason code identifying why the transactions have not been fully qualified. In some embodiments, these non-qualified transactions, and their reason codes, may be accessed by the payment processing network for analysis, and for dispute resolution and customer service. In some embodiments, FQTs may be returned to the payment processing network.

Processing continues at 212 where the reward amounts (that are paid to the cardholders at 214, below) are recouped or settled with the individual merchants. Pursuant to some embodiments, processing at 212 is performed by the rewards servicing entity 124 by direct billing individual merchants 105 to fund the aggregate amount of the discounts paid out. In some embodiments, processing at 212 may be performed on a regular basis (e.g., such as weekly or monthly). In some embodiments, the payment network may collect directly from merchants via each merchant's acquirer.

Processing continues at 214 where the payment processing network 108, using the FQT file, causes the amount of each reward or discount to be credited to the appropriate cardholder payment accounts. In some embodiments, this is performed by establishing a payment message that causes the amount of the reward or discount to be credited to the issuer for subsequent crediting to the appropriate cardholder account. Subsequently, a corresponding amount is caused to be debited from a settlement account (e.g., such as an account held by the rewards servicing entity 124). Each of these payment messages are processed using the authorization, clearing and settlement systems 110 and cause the funds to be credited to the cardholder account, and debited from the settlement account. In some embodiments, issuers may convert the amount of a reward or discount to points prior to crediting to a cardholder. In some embodiments, issuers may aggregate the amount of rewards or discounts in a batch account prior to crediting or distributing the rewards or discounts to their cardholders.

Pursuant to some embodiments, processing at 214 includes reconciling the FQT transactions with the previously-created PQT transaction file to ensure that all FQT transactions were in fact originally identified as PQT transactions.

Pursuant to some embodiments, funds processed at 214 are settled between the rewards servicing entity 124 and issuers (and subsequently to individual cardholders) by treating the rewards servicing entity 124 as a special purpose acquirer. The individual rewards or discounts credited to cardholder accounts may be delivered using a MasterCard® transaction referred to as a “Payment To” transaction that posts to issuers in the next clearing cycle. The funds will be debited from an account held by or on behalf of the rewards servicing entity 124, and credited to the issuer associated with the cardholder account. The issuer then posts the appropriate reward amounts to each cardholder account.

The result is a rewards system and method which allows participation of a wide variety of different merchants offering different rewards and discounts to a wide variety of consumers who can shop and enjoy rewards and discounts without special action on their part at the point of sale (and without use of a number of different loyalty or store cards). Further, consumers receive the benefit of rewards and discounts quickly and efficiently. Further still, consumers may enjoy participation without need to enroll or register; instead, in some embodiments, consumers may be automatically enrolled by virtue of their holding a payment account issued by a participating issuer.

Reference is now made to FIG. 3 where a merchant setup process 300 pursuant to some embodiments is shown. Process 300 may be performed, for example, by a payment processing network (such as the network 108 of FIG. 1) and may rely on data such as merchant location data (e.g., in datastore 116 of FIG. 1) and data received from a rewards servicing entity such as entity 124 of FIG. 1. Pursuant to some embodiments, process 300 is performed for each merchant that wishes to participate in a rewards program of the present invention. Before a merchant can offer a reward or discount through the rewards program, process 300 should be completed for that merchant.

Processing begins at 302 where new merchant sign-up information is received. In some embodiments, a rewards servicing entity 124 manages the registration and sign-up of new merchants by marketing the rewards program to different merchants. In some embodiments, the rewards servicing entity 124 collects information from each merchant that wishes to participate, including, for example the following types of information:
A merchant identifier (or “MID”),
merchant name, confirmation that the merchant accepts the payment card processed by the payment network 108,
the merchants headquarters address,
the merchant's Dunn & Bradstreet number,
if applicable, one or more “doing business as” (DBA) or trade names,
the merchant's Federal Tax ID,
an approximate number of merchant locations, specific information for Internet, Catalog and other sales venues, and
other unique identifying information associated with the merchant.
   This information may be provided by the rewards servicing entity 124 to the payment processing network 108 (or, more particularly, in some embodiments, to the rewards systems 122) in any of a number of different forms, including as an electronic mail, a file, an XML file or post, etc.

Processing continues at 304 where a merchant database (such as the merchant location database 116 of FIG. 1) is queried to identify potential merchant matches for the new merchant. For example, processing at 304 attempts to identify an existing unique merchant identifier that exists in a database of merchants that currently accept the payment card of the payment processing network 108. Processing at 304 identifies possible matches. For example, processing at 304 may identify three or four potential matches between the merchant information provided at 302 and existing merchants in merchant location database 116. These potential matches are returned to the reward servicing entity 124 at 306 so that the rewards servicing entity may confirm which, if any, of the potential matches is the correct merchant. In some situations, a correct match may not be identified without further research by the rewards servicing entity 124 or the payment processing network 108. Once a match has been confirmed, processing continues at 308 where the newly registered merchant is associated with an existing merchant identifier from merchant location database 116.

Upon completion of processing at 308, both the rewards servicing entity 124 and the rewards system 122 have registration information for the new merchant which includes a unique merchant identifier. The unique merchant identifier matches an identifier from merchant location database 116, and may be used in transaction processing to identify consumer transactions that may be eligible for a reward. In some embodiments, a unique merchant identifier may identify an entire chain of merchant locations (e.g., all Walmart® locations may be associated with a merchant identifier). In some embodiments, individual stores or locations may be associated with a merchant identifier. In this manner, merchants may control or offer rewards programs at local or regional levels. By uniquely identifying a large number of merchants and merchant locations, rewards and discounts may be delivered in a manner which both motivates and rewards specific purchasing behavior.

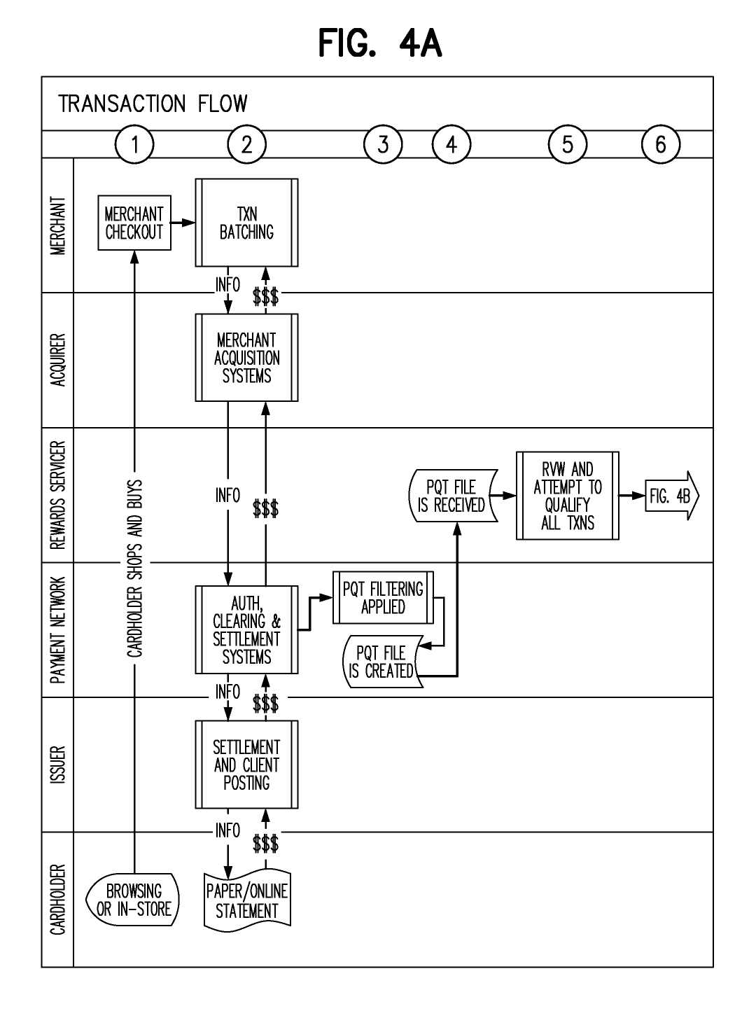

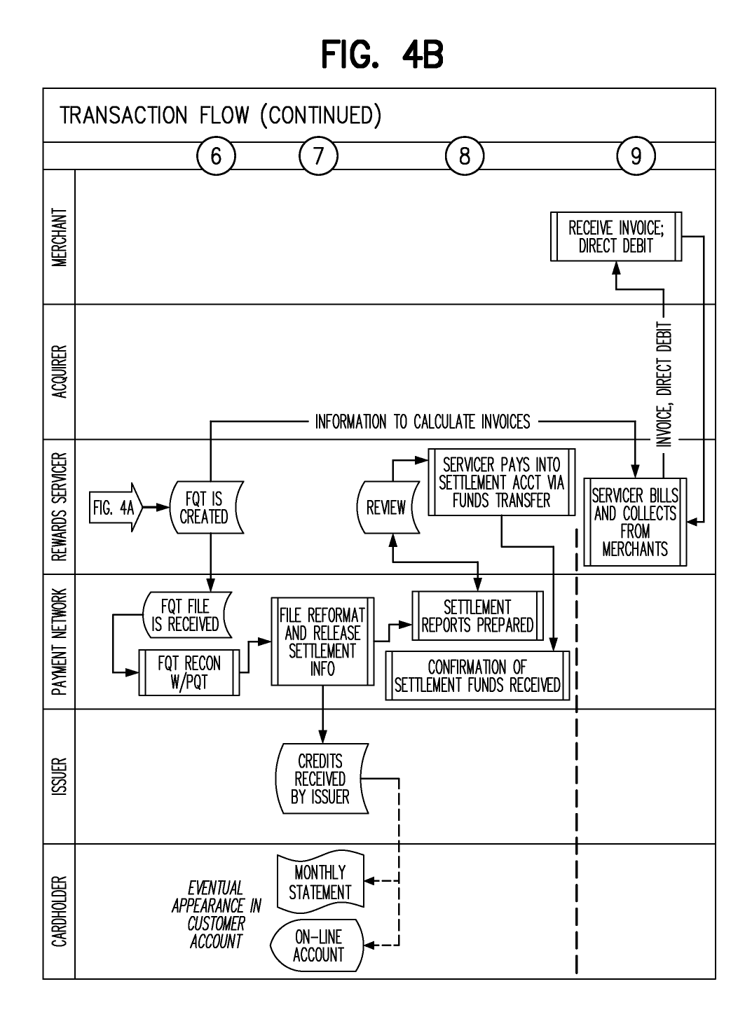

Reference is now made to FIGS. 4A and 4B, where a transaction process 400 is shown pursuant to some embodiments. Process 400 depicts the overall transaction processing flow beginning with a customer purchase (shown in column (1) of FIG. 4A) through settlement of the reward or discount amount with the merchant (shown in column (9) of FIG. 4B). In the embodiment depicted in FIGS. 4A and 4B, the entities introduced in FIG. 1 are shown on the left-hand column, including a cardholder, an issuer (e.g., the issuer 112 of FIG. 1), a payment network (e.g., the payment processing network 108 of FIG. 1), a rewards servicer (e.g., the rewards servicing entity 124 of FIG. 1), an acquirer (e.g., the acquirer 106 of FIG. 1), and a merchant (e.g., the merchant processing system 104 of FIG. 1). Those skilled in the art, upon reading this disclosure, will recognize that a large number of transactions such as that depicted in FIG. 4 may be processed at any given time. Those skilled in the art will also recognize that some of the functions performed by the entities represented in FIG. 4 may be performed by the same entity (e.g., the processing performed by the payment network and the rewards servicer may be performed by a single entity, or by multiple entities).

The processing of FIGS. 4A and 4B will be described by referring to the column numbers at the top of the figures, generally describing the processing in the sequence in which the processing occurs. Referring first to the processing at column (1), processing begins when a registered cardholder shops at a merchant location (e.g., such as at a physical store, an Internet store, mail order, or the like) and purchases one or more items using a registered payment card (i.e., a payment card that has been registered for participation in a rewards program pursuant to the present invention).

Referring now to the processing in column (2), the merchant (again, a registered merchant, registered to participate in the rewards program of the present invention), operates a merchant processing system or similar payment processing system, and causes the completed transaction information to be batched or otherwise transmitted to an acquirer for settlement processing and possible rewards processing. The acquirer systems cause the transaction information to be transmitted to authorization, clearing and settlement systems operated by the payment network, which in turn communicates with the payment card issuer to perform settlement processing. The issuer provides funds, then collects funds from the customers payment card account and updates the cardholders statement to reflect the transaction. The payment network provides the funds from the issuer to the acquirer systems for crediting to the merchant account. In general, the processing in column (2) of FIG. 4A involves standard payment card processing.

Processing continues with the processing in column (3), where the payment network (or, more particularly, in some embodiments, the rewards systems 122 of the payment processing network 108) generates a PQT file based on the transactions processed in column (3). The PQT file is created, in some embodiments, using the processing described above in conjunction with FIG. 2.

Referring to the processing in column (4), the rewards servicing entity receives the PQT file (e.g., via file transfer protocol, email, or other communication means), and in column (5) reviews the entries in the PQT to attempt to qualify all of the transactions included in the PQT. For example, individual transactions may be qualified as described in conjunction with FIG. 2 above. Processing continues at column (7) of FIG. 4B, where the rewards servicer creates a FQT file. The FQT file is transmitted to the payment network for reconciliation with the PQT file (again, as described in conjunction with FIG. 2 above) and is also stored for later use in calculating invoices for presentment to merchants.

Referring to the processing in column (7), the payment network processes the FQT file and causes settlement records to be created and processed to credit the cardholder in the amount of the reward or discount. The settlement records cause credit messages to be received by the issuer of the customer's payment card, and the issuer processes the credit message to credit the cardholder's account. The issuer also uses the credit message information to update the cardholder's monthly statement and account information.

In column (8), the payment network uses the settlement records to prepare settlement reports for the rewards that were processed. This information may be used to allow the rewards servicer to recoup the reward amounts from the appropriate merchants, and to ensure that the rewards servicer funds a settlement account with the appropriate amount of funds (e.g., equal to or greater than the total of the rewards processed in column (7)). The rewards servicer, upon receipt of the settlement reports, causes funds to be deposited into a settlement account (e.g., via funds transfer). The payment network may perform processing to confirm that sufficient funds were deposited in the settlement account before performing any further processing of rewards (the next day's transactions).

At column (9), processing occurs in which the rewards servicer bills and collects reward amounts from merchants. Processing at column (9) may be done on a cycle different than that of columns (1)-(8) (e.g., the processing of columns (1)-(8) may be done daily, while the processing at column (9) may be done monthly or on some other schedule). In this manner, cardholders enjoy nearly immediate confirmation of rewards earned. Further, cardholders are able to enjoy reward offers from multiple merchants, without needing to carry multiple reward or loyalty cards.

An advantage of the processes described herein is that they allow merchants to create loyalty programs for customers, while conveniently funding and fulfilling the rewards by using the administrative, accounting and data processing capabilities of a pre-existing payment processing network and using the services of a rewards servicing entity. The rewards are credited directly to customers' payment card accounts and are charged to the funding merchants in batches (e.g., by the rewards servicing entity), thereby reducing the expense and effort required for a merchant to create and manage a loyalty program.

In some embodiments, the reward programs may include purchase of specific products or services as a qualifying condition for the rewards, in addition to or instead of other qualifying conditions such as date, amount and/or location of purchases. These qualifying conditions may be analyzed and identified by the rewards servicing entity 124 when analyzing the PQT file, and may include further interaction between the merchant processing systems and the rewards servicing entity. The item identifying information may, for example, be in the form of a stock keeping unit (SKU) number, or a Universal Product Code (UPC) number. According to other examples, a specific indication of the service purchased may be provided, such as origin-destination city pair and/or fare class in the case of an airline flight, or class of vehicle in the case of a car rental agency. In this way, merchants may tie qualification for rewards to the purchase of specific items or categories of items. Consequently, loyalty programs, implemented using features of the present invention, may take the place of product-specific coupons. This may have the advantage of eliminating the need for the merchant to issue and the customer to redeem coupons.

Up to now, aspects of the present invention have largely been described in the context of crediting payment card accounts that belong to individual consumers. However, the principles of the present invention are also applicable to rewards and discounts provided by crediting payment transactions to payment card accounts owned by small, medium and large businesses and other entities, and/or issued to employees of businesses and other entities, which are responsible for paying charges to such accounts. In some embodiments, rewards may be directed to payment card accounts not directly associated with individual consumers and/or payment card accounts issued to individual employees. In some embodiments, rewards or discounts may be converted to some other reward scheme (e.g., such as a point scheme or the like). For example, the conversion may be performed by individual issuers.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A reward processing method, comprising:
analyzing transaction data associated with a plurality of payment transactions, each payment transaction including data identifying a payment account identifier, a transaction date, a transaction amount, and a merchant identifier;
identifying a first set of said payment transactions involving registered payment account identifiers;
identifying, from said first set, a second set of said payment transactions involving a registered merchant identifier and a current offer;
calculating, for each of said payment transactions in said second set, a reward amount earned; and
crediting said reward amount earned to each of said payment account identifiers in said second set.

2. The method of claim 1, wherein said identifying said second set of payment transactions further comprises:
generating a pre-qualified transaction file; and
providing said pre-qualified transaction file to at least one of a servicing entity and an internal system for final qualification of said transactions as involving a current offer.

3. The method of claim 1, wherein said current offer is identified by comparing each of said transactions to a daily offer file containing all current offers.

4. The method of claim 1, wherein said daily offer file includes current offers.

5. The method of claim 1, wherein said crediting said reward amount further comprises:
creating a payment message instructing an issuer or processor of each of said payment account identifiers in said second set to credit said calculated reward amount earned to each of said payment accounts identified by said payment account identifiers.

6. The method of claim 1, further comprising:
creating a settlement report for said second set of payment transactions, said settlement report including a total of said reward amounts in said settlement report;
providing said settlement report to a rewards servicing entity; and
confirming that a payment in the amount of said total has been received from said rewards servicing entity.

7. The method of claim 1, further comprising registering at least a first merchant to become a registered merchant, the method comprising:
receiving a merchant registration request including information identifying a prospective merchant;
comparing said information identifying said prospective merchant with a database of merchants associated with a payment network, said database identifying said merchants using a unique merchant identifier; and
assigning at least one of said unique merchant identifiers to said prospective merchant and registering said prospective merchant for participation in said rewards program.

8. A rewards apparatus, comprising:
a processor; and
a memory in communication with the processor, the memory storing program instructions, the processor operative with the program instructions to:
analyze transaction data associated with a plurality of payment transactions, each payment transaction including data identifying a payment account identifier, a transaction date, a transaction amount, and a merchant identifier;
identify a first set of said payment transactions involving registered payment account identifiers;
identify, from said first set, a second set of said payment transactions involving a registered merchant identifier and a current offer;
calculate, for each of said payment transactions in said second set, a reward amount earned; and
credit said reward amount earned to each of said payment account identifiers in said second set.

9. The rewards apparatus of claim 8, wherein the program instructions to identify said second set of payment transactions further comprises program instructions to:
generate a pre-qualified transaction file; and
provide said pre-qualified transaction file to at least one of a servicing entity and an internal system for final qualification of said transactions as involving a current offer.

10. The rewards apparatus of claim 8, wherein said current offer is identified by comparing each of said transactions to a daily offer file containing all current offers.

11. The rewards apparatus of claim 8, wherein said daily offer file includes current offers.

12. The rewards apparatus of claim 8, wherein said program instructions to credit said reward amount further comprises program instructions to:
create a payment message instructing an issuer or processor of each of said payment account identifiers in said second set to credit said calculated reward amount earned to each of said payment accounts identified by said payment account identifiers.

13. The rewards apparatus of claim 8, further comprising program instructions to:
create a settlement report for said second set of payment transactions, said settlement report including a total of said reward amounts in said settlement report;
provide said settlement report to a rewards servicing entity; and
confirm that a payment in the amount of said total has been received from said rewards servicing entity.

14. The rewards apparatus of claim 8, further comprising program instructions to register at least a first merchant to become a registered merchant, and further comprising program instructions to:
receive a merchant registration request including information identifying a prospective merchant;
compare said information identifying said prospective merchant with a database of merchants associated with a payment network, said database identifying said merchants using a unique merchant identifier; and
assign at least one of said unique merchant identifiers to said prospective merchant and registering said prospective merchant for participation in said rewards program.

15. A computer-implemented method for processing rewards, comprising:
analyzing, using a rewards processing computer, transaction data associated with a plurality of payment transactions, each payment transaction including data identifying a payment account identifier, a transaction date, a transaction amount, and a merchant identifier;
identifying a first set of said payment transactions involving registered payment account identifiers;
identifying, from said first set, a second set of said payment transactions involving a registered merchant identifier and a current offer;
calculating, for each of said payment transactions in said second set, a reward amount earned; and
crediting, using a clearing and settlement system, said reward amount earned to each of said payment account identifiers in said second set.
